(19) United States
(12) Patent Application Publication
(10) Pub. No.: US 2021/0305630 A1
(43) Pub. Date: Sep. 30, 2021

(54) POSITIVE ELECTRODE FOR SOLID-STATE BATTERY, MANUFACTURING METHOD FOR POSITIVE ELECTRODE FOR SOLID-STATE BATTERY, AND SOLID-STATE BATTERY

(71) Applicant: HONDA MOTOR CO., LTD., Tokyo (JP)

(72) Inventors: Masahiro OHTA, Saitama (JP); Takuya TANIUCHI, Saitama (JP)

(21) Appl. No.: 17/260,228

(22) PCT Filed: Jul. 12, 2019
(86) PCT No.: PCT/JP2019/027767

§ 371 Date: Jan. 14, 2021

(30) Foreign Application Priority Data
Jul. 18, 2018 (JP) 2018-135100

(51) Int. Cl. H01M 10/0585; H01M 10/0525; H01M 4/62; H01M 4/139; H01M 10/0562; H01M 50/534

(52) U.S. Cl. CPC H01M 10/0585; H01M 10/0525; H01M 4/62; H01M 2004/028; H01M 10/0562; H01M 50/534; H01M 4/139

(57) ABSTRACT

A positive electrode for a solid-state battery, a manufacturing method for a positive electrode for a solid-state battery, and a solid-state battery are provided, with which the occurrence of lamination misalignment in a lamination step when manufacturing a solid-state battery and the occurrence of cracking at the time of lamination pressing, as well as short-circuiting due to contact with a tab, can be suppressed. For a collector of an electrode layer, a coating layer is formed not only on the outer side of an active material layer including an active material but also on end faces of the collector.

This application is based on and claims the benefit of priority from Japanese Patent Application No. 2018-135100, filed on 18 Jul. 2018, the content of which is incorporated herein by reference.

### TECHNICAL FIELD The present invention relates to a positive electrode for solid-state batteries, a manufacturing method for a positive electrode for solid-state batteries, and a solid-state battery.

### BACKGROUND ART

Thus far, lithium ion secondary batteries are becoming widespread as secondary batteries having high energy density.

Lithium ion secondary batteries have a structure made by interposing a separator between the positive electrode and negative electrode, and a liquid electrolyte (electrolytic solution) being filled therein.

The electrolytic solution of a lithium-ion secondary battery is usually a flammable organic solvent, and thus there have been cases where the safety to heat becomes a particular problem.

Therefore, a solid-state battery made using an electrolyte of an inorganic solid in place of the electrolyte of organic liquid has been proposed (refer to Patent Document 1).

Compared to a battery using an electrolytic solution, the solid-state battery made from a solid electrolyte can eliminate the problem of heat, and respond to the demand for higher capacity and higher voltage by way of laminating.

In addition, it can also contribute to a size decrease.

However, in order to further promote utilization of solid-state batteries, various improvements are still necessary.

As factors requiring improvement, for example, the lamination displacement occurring in the lamination process during manufacture, cracks occurring upon the lamination pressing, short circuiting from tab contact, etc. can be exemplified.

To address these demands, a method of establishing the surface areas of the positive electrode layer, negative electrode layer and electrolyte layer in a specific relationship, and arranging an insulation member on either the positive electrode layer or negative electrode layer and matching the outer diameters thereof has been proposed (refer to Patent Document 2).

However, with the method disclosed in Patent Document 2, the short circuit risk due to tab contact has yet to be eliminated, and thus further improvement is desired.

Patent Document 1: Japanese Unexamined Patent Application, Publication No. 2000-106154

Patent Document 2: Japanese Unexamined Patent Application, Publication No. 2015-125893

### DISCLOSURE OF THE INVENTION

### Problems to be Solved by the Invention

The present invention has been made taking account of the above-mentioned background art, and an object thereof is to provide a positive electrode for solid-state batteries, a manufacturing method for a positive electrode for solid-state batteries, and a solid-state battery which suppress lamination displacement occurring in the lamination process during solid-state battery manufacture, cracks occurring upon the lamination pressing, as well as are able to suppress short circuit from tab contact.

### Means for Solving the Problems

The present inventors have thoroughly studied the location at which arranging an insulation layer in the laminate body of a solid-state battery, upon solving all of the above problems at the same time.

As a result thereof, it was found that, by providing a coating layer in a collector constituting an electrode layer not only on an outer side of an active material layer containing active material, but also at the same time on an end face of the collector, it is possible to suppress lamination displacement occurring in a lamination step during manufacturing, and cracks occurring in lamination pressing, as well as possible to suppress short circuit due to tab contact, thereby arriving at completion of the present invention.

More specifically, an aspect of the present invention is a positive electrode for solid-state batteries including: a positive electrode collector; and a positive electrode active material layer containing a positive electrode active material formed on the positive electrode collector, in which the positive electrode collector has, on at least one side of an outer peripheral section of a surface having the positive electrode active material layer, a positive electrode active material unformed section in which the positive electrode active material layer is not formed, and has, on the positive electrode active material layer unformed section, and an end face connected to the positive electrode active material layer unformed section, a positive electrode collector coating layer consisting of an insulation layer formed by an insulating material and/or a solid electrolyte layer formed by solid electrolyte.

Thickness of the positive electrode collector coating layer formed on the positive electrode collector may be substantially the same as thickness of the positive electrode active material layer.

The positive electrode for solid-state batteries may have a positive electrode tab connected to the positive electrode collector, and the positive electrode tab may at least partly have a positive electrode tab coating layer consisting of an insulating material.

In addition, another aspect of the present invention is a manufacturing method for a positive electrode for solid-state batteries including a positive electrode collector, and a positive electrode active material layer containing a positive electrode active material formed on the positive electrode collector, the method including the steps of: forming a positive electrode active material layer containing a positive electrode active material on the positive electrode collector; and forming a positive electrode collector coating layer consisting of an insulation layer formed by an insulating material and/or a solid electrolyte layer formed by a solid electrolyte, in a region of the positive electrode collector not having the positive electrode active material layer.

Furthermore, another aspect of the present invention is a solid-state battery including:

a positive electrode for solid-state batteries containing a positive electrode collector, and a positive electrode active material layer including positive electrode active material formed on the positive electrode collector; a negative electrode for solid-state batteries containing a negative electrode collector, and a negative electrode active material layer including a negative electrode active material formed on the negative electrode collector; and a solid electrolyte layer disposed between the positive electrode for solid-state batteries and the negative electrode for solid-state batteries, in which the positive electrode for solid-state batteries is the above-mentioned positive electrode for solid-state batteries.

It is desirable for surface area of the positive electrode active material layer to be no more than surface area of the negative electrode active material layer.

Surface area of the positive electrode for solid-state batteries, surface area of the negative electrode for solid-state batteries, and surface area of the solid electrolyte layer may be substantially the same.

The negative electrode collector may have a negative electrode active material layer unformed section in which the negative electrode active material layer is not formed, on at least one side of an outer peripheral section of a surface having the negative electrode active material layer, and have a negative electrode collector coating layer consisting of an insulation layer formed by an insulating material and/or a solid electrolyte layer formed by a solid electrolyte, on the negative electrode active material layer unformed section and an end face connected to the negative electrode active material layer unformed section.

Thickness of the negative electrode collector coating layer may be substantially the same as thickness of the negative electrode active material layer.

### Effects of the Invention

According to the present invention, it is possible to realize a solid-state battery which suppresses lamination displacement occurring in the lamination process during solid-state battery manufacture, cracks occurring upon the lamination pressing, as well as being able to suppress short circuit from tab contact.

### BRIEF DESCRIPTION OF THE DRAWINGS

FIGS. 1A and 1B are views showing a positive electrode for solid-state batteries according to an embodiment of the present invention; and

FIG. 2 is a cross-sectional view of a solid-state battery according to an embodiment of the present invention.

### PREFERRED MODE FOR CARRYING OUT THE INVENTION

Hereinafter, an embodiment of the present invention will be explained while referencing the drawings. However, the embodiment shown below is to exemplify the present invention, and the present invention is not to be limited to the following description.

<Positive Electrode for Solid-State Batteries>

The positive electrode for solid-state batteries of the present invention includes: a positive electrode collector; a positive electrode active material layer including a positive electrode active material formed on the positive electrode collector; and a positive electrode collector coating layer.

The positive electrode collector has a positive electrode active material layer unformed section in which the positive electrode active material layer is not formed, on at least one side of the outer peripheral section of a surface having the positive electrode active material layer; and has a positive electrode collector coating layer consisting of the an insulation layer formed by an insulating material and/or a solid electrolyte layer formed by solid electrolyte, on this positive electrode active material unformed section and one end face having the positive electrode active material layer unformed section.

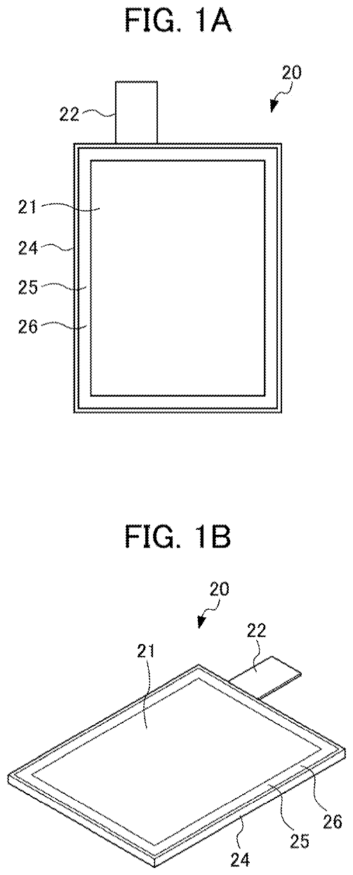

FIGS. 1A and 1B show the positive electrode for solid-state batteries according to the embodiment of the present invention. FIG. 1A is a top view of a positive electrode for solid-state batteries 20, and FIG. 1B is a perspective view.

In the positive electrode for solid-state batteries 20 according to the embodiment shown in FIGS. 1A and 1B, a positive electrode active material layer 21 is formed on a positive electrode collector 25. In the positive electrode collector 25, a positive electrode active material layer unformed section 26 in which the positive electrode active material layer is not formed exists on all sides (all four sides) of the outer periphery of the positive electrode active material layer 21, and the positive electrode collector 25 has a positive electrode collector coating layer 24 on all of the positive electrode active layer unformed sections 26 and all end faces coupled to this positive electrode active layer unformed sections 26.

In addition, the positive electrode for solid-state batteries 20 includes a positive electrode tab 22 coupled to the positive electrode collector 25.

(Positive Electrode Active Material Layer)

The positive electrode for solid-state batteries of the present invention has a positive electrode active material layer containing the positive electrode active material on the positive electrode collector.

The positive electrode active material which can be applied to the present invention is not particularly limited, and it is possible to apply well-known materials as the positive electrode active material of a solid-state battery.

There are no particular limitations for the composition thereof, and may contain solid electrolyte, conductive auxiliary agent, binding agent, etc.

As the positive electrode active material contained in the positive electrode active material layer of the present invention, for example, transition metal chalcogenides such as titanium disulfide, molybdenum disulfide and niobium selenium; transition metal oxides such as lithium nickel oxide (LiNiO₂), lithium manganate (LiMnO₂, LiMn₂O₄) and lithium cobalt oxide (LiCoO₂), etc. can be exemplified.

(Positive Electrode Collector)

The collectors which can be applied to the positive electrode for solid-state batteries of the present invention are not particularly limited, and a well-known collector that can be used in the positive electrode of a solid-state battery can be applied.

For example, metal foils such as SUS foil or Al foil can be exemplified.

In addition, foam metal or conductive carbon sheet (for example, graphite sheet or CNT sheet), etc. can also be exemplified.

(Positive Electrode Active Material Layer Unformed Section)

The positive electrode collector in the positive electrode for solid-state batteries of the present invention has the positive electrode active layer unformed section in which the positive electrode active material layer is not formed, on at least one side of the outer peripheral section of a surface having the above-mentioned positive electrode active material layer.

In other words, the positive electrode active material layer is not present in the positive electrode active material layer unformed section, and becomes a portion in which the positive electrode collector exists as is.

In the solid-state battery, due to the positive electrode active material layer not being present and the positive electrode collector being exposed as is, the positive electrode active material layer unformed section becomes a region in which a void is produced at a height corresponding to the thickness of the positive electrode active material layer, upon laminating the solid electrolyte and negative electrode for solid-state batteries, in a solid-state battery manufacturing process.

Therefore, upon pressing after making a laminate, it becomes a region inducing the generation of cracks.

(Positive Electrode Collector Coating Layer)

The positive electrode for solid-state batteries of the present invention has the positive electrode collector coating layer consisting of an insulation layer formed by an insulating material and/or a solid electrolyte layer formed by solid electrolyte, at the above-mentioned positive electrode active material layer unformed section, and an end face of the positive electrode collector coupled to the positive electrode active material layer unformed section.

End face of the positive electrode collector of the present invention is a surface which is the thickness of the positive electrode for solid-state batteries 20 as shown in FIG. 1B, i.e. side face in the lamination direction upon forming the solid-state battery.

In the positive electrode for solid-state batteries 20 shown in FIGS. 1A and 1B, the positive electrode active material layer 21 has a rectangular shape, the positive electrode active material layer unformed section 26 exists on all four sides of the outer peripheral section of the surface having the positive electrode active material layer 21 on the positive electrode collector 25, and has the positive electrode collector coating layer 24 on all four sides of the positive electrode active material layer unformed section 26, and the end face connected to the positive electrode active material layer unformed section.

With the positive electrode for solid-state batteries of the present invention, by having the positive electrode collector coating layer on the positive electrode active material layer unformed section of the positive electrode collector, the positive electrode collector coating layer comes to be a support of the void, in the pressing process after laminating the positive electrode for solid-state batteries with the solid electrolyte and negative electrode for solid-state batteries in the solid-state battery manufacturing process. For this reason, it is possible to suppress the occurrence of cracks.

In addition, the positive electrode for solid-state batteries of the present invention is characterized by having the positive electrode collector coating layer not only on the positive electrode active material layer unformed section, but also at the same time on the end face connecting to the positive electrode active material unformed section.

In the present invention, by having the positive electrode collector coating layer at the same time on the end face connecting to the positive electrode active material layer unformed section, even in the case of the negative electrode tab connected to the negative electrode for solid-state batteries making contact with the positive electrode for solid-state batteries at the time of solid-state battery manufacture, at the time of solid-state battery usage, etc., it becomes possible to prevent short circuit.

In addition, by having the positive electrode collector coating layer not only on the positive electrode active material unformed section, but also at the same time on the end face connected to the positive electrode active material layer unformed section, the profile becomes clear, and it is possible to further suppress laminate displacement occurring during manufacture.

(Materials)

The positive electrode collector coating layer consists of an insulation layer formed by an insulating material and/or a solid electrolyte layer formed by solid electrolyte.

In the case of constituting by both the insulation layer and solid electrolyte layer, it is preferable to form the solid electrolyte layer after forming the insulation layer on the outside thereof.

The insulating material constituting the insulation layer serving as the positive electrode collector coating layer is not particularly limited.

For example, it is possible to exemplify resins having an insulation property, and a thermoplastic insulation resin such as polyethylene, polypropylene, polystyrene and ABS resin, or thermosetting insulation resin such as phenol resin, epoxy resin, polyurethane and alkyd resin, or the like can be exemplified.

The solid electrolyte constituting the solid electrolyte layer serving as the positive electrode collector coating layer is not particularly limited, and can adopt an electrolyte that forms a solid-state battery.

For example, it is possible to exemplify a sulfide-based inorganic solid electrolyte, NASICON-type oxide-based inorganic solid electrolyte, perovskite-type oxide inorganic solid-state modified electrolyte, etc.

In the present invention, it is preferable to define as the same substance as the solid electrolyte used in the solid electrolyte layer upon configuring a solid-state battery, and is particularly preferably a sulfide-based inorganic solid electrolyte.

(Thickness)

The thickness of the positive electrode collector coating layer formed on the positive electrode collector is preferably substantially the same as the thickness of the positive electrode active material layer. The thickness of the positive electrode collector coating layer, if being substantially the same as the thickness of the positive electrode active material layer, will be substantially the same as the height of the void of the positive electrode active material layer unformed section existing at a height corresponding to the thickness of the positive electrode active material layer.

For this reason, it becomes possible to minimize the flatness tolerance and parallelism tolerance of the obtained positive electrode for solid-state batteries, a result of which the volume upon multi-layering becomes smaller, and higher laminating becomes possible, which can contribute to higher energy.

In addition, since the geometric tolerance upon making a laminate is small, it is possible to suppress the occurrence of cracks since it becomes possible to uniformly apply pressure in the lamination pressing during manufacturing.

(Positive Electrode Tab)

The positive electrode for solid-state batteries of the present invention preferably has a positive electrode tab connected to the positive electrode collector.

The positive electrode tab projects from an end of the positive electrode collector, and plays the role of connecting the positive electrode collector and a positive electrode terminal.

The material thereof is not particularly limited; however, for example, by establishing as the same material as the positive electrode collector, welding becomes easy, and thus can decrease the contact resistance.

As the positive electrode tab material, aluminum, stainless steel or the like can be exemplified, and surface treatment such as nickel plating may be conducted as necessary.

(Positive Electrode Tab Coating Layer)

The positive electrode tab preferably has a positive electrode tab coating layer consisting of insulating material on at least one part.

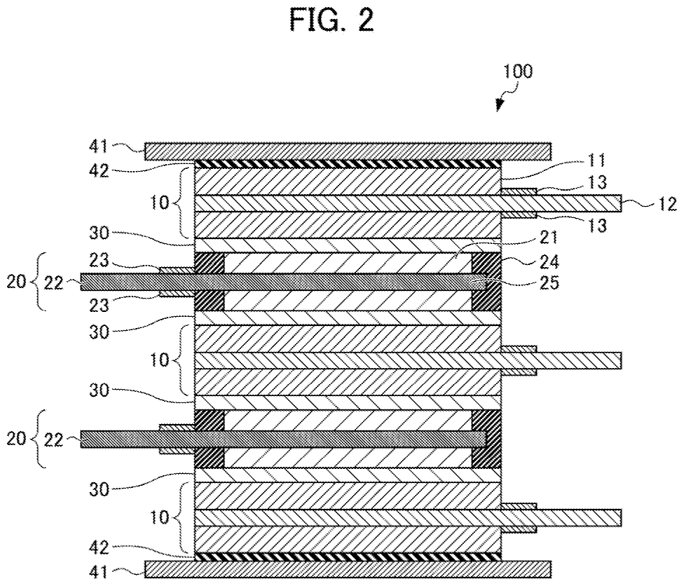

FIG. 2 is a cross-sectional view of the solid-state battery according to the embodiment of the present invention described later. In the solid-state battery 100 shown in FIG. 2, the positive electrode for solid-state batteries 20 (shown in FIGS. 1A and 1B) which is an embodiment of the positive electrode for solid-state batteries of the present invention constitutes part of the laminate which is the solid-state battery 100.

As shown in FIG. 2, the positive electrode tab 22 of the positive electrode for solid-state batteries 20 connects to the positive electrode collector 25, and the positive electrode tab coating layer 23 is arranged so as to coat the outer periphery of the positive electrode tab 22 at the vicinity of the connecting part thereof, i.e. vicinity of the end of the positive electrode collector.

By the positive electrode tab having a positive electrode tab coating layer consisting of insulating material, even in a case of the negative electrode tab or negative electrode collector end contacting with the positive electrode tab at the time of solid-state battery manufacture, at the time of solid-state battery use or the like, it is possible to prevent short circuit.

<Manufacturing Method for Positive Electrodes for Solid-State Batteries>

The manufacturing method for positive electrodes for solid-state batteries of the present invention includes: a positive electrode active material layer forming step of forming the positive electrode active material layer containing positive electrode active material on the positive electrode collector; and a positive electrode collector coating layer forming step of forming the positive electrode collector coating layer consisting of the insulation layer formed by insulating material and/or the solid electrolyte layer formed by solid electrolyte, in a region not having the positive electrode active material layer of the positive electrode collector.

(Positive Electrode Active Material Layer Forming Step)

The positive electrode active material layer forming step is a step of forming the positive electrode active material layer containing positive electrode active material on the positive electrode collector. The method of forming the positive electrode active material layer is not particularly limited; however, a method which prepares a positive electrode mixture containing positive electrode active material, coats the positive electrode mixture on the positive electrode collector, and then dries can be exemplified.

The coating method is not particularly limited and, for example, a doctor blade method, spray coating, screen printing or the like can be exemplified.

In the positive electrode active material layer forming step, it is preferable to conduct intermittent coating which alternately provides a coated portion which coats the positive electrode mixture and an uncoated portion which does not coat, on the positive electrode collector.

In the intermittent coating, it is possible to form the positive electrode active material layer unformed section between adjacent positive electrode active material layers.

In addition, the positive electrode active material layer forming step of the present invention may conduct rolling, after coating and drying the positive electrode mixture layer that becomes the positive electrode active material layer.

By rolling, it is possible to improve the filling rate of the positive electrode active material, and possible to obtain a positive electrode for solid-state batteries of high capacity.

(Positive Electrode Collector Coating layer Forming Step)

The positive electrode collector coating layer forming step is a step of forming the positive electrode collector coating layer consisting of the insulation layer formed by insulating material and/or the solid electrolyte layer formed by solid electrolyte.

The method of forming the insulation layer and/or solid electrolyte layer is not particularly limited, and can be appropriately selected according to the type of insulating material and solid electrolyte to be used.

For example, in the case of forming the positive electrode active material layer by intermittent coating, a method of forming the positive electrode collector coating layer by coating the material(s) forming the insulation layer and/or solid electrolyte layer on the positive electrode active material layer unformed section to be formed can be exemplified.

Alternatively, a method of coating the material for forming the insulation layer and/or solid electrolyte layer, on the positive electrode collector surface by a dry method or wet method, in a state masking the portion in which not to form the positive electrode collector coating layer can be exemplified. It is also possible to coat the insulation layer and/or solid electrolyte layer by spraying or the like.

(Other Steps) The manufacturing method for the positive electrode for solid-state batteries of the present invention may have a punching step of separately punching a laminate having the positive electrode active material layer and positive electrode collector coating layer formed on the positive electrode collector into electrodes.

In addition, in the manufacturing method for the positive electrode for solid-state batteries of the present invention, the above-mentioned positive electrode collector coating layer forming step may be conducted on the end face of the positive electrode collector formed by the punching step.

<Solid-State Battery>

The solid-state battery of the present invention includes: a positive electrode for solid-state batteries containing a positive electrode collector, and a positive electrode active material layer containing a positive electrode active material formed on the positive electrode collector; a negative electrode for solid-state batteries containing a negative electrode collector and a negative electrode active material layer containing a negative electrode active material formed on the negative electrode collector; and a solid-state electrolyte layer arranged between the positive electrode for solid-state batteries and the negative electrode for solid-state batteries, in which the positive electrode for solid-state batteries is characterized by being the positive electrode for solid-state batteries of the present invention described above.

FIG. 2 shows a cross-sectional view of a solid-state battery which is an embodiment of the present invention. The solid-state battery 100 shown in FIG. 2 has a structure in which the negative electrode for solid-state batteries 10, positive electrode for solid-state batteries 20 and solid electrolyte layer 30 arranged between these are repeatedly laminated.

On the outer side of the negative electrode for solid-state batteries 10 arranged as the outside layer of the laminate, a support plate 41 is arranged via an insulation film 42.

In the negative electrode for solid-state batteries 10 constituting the solid-state battery 100 that is the embodiment, the negative electrode active material layer 11 is laminated on both sides of the negative electrode collector.

The negative electrode tab connects to the negative electrode collector (collectively set as 12 in FIG. 2), and the negative electrode tab coating layer 13 is arranged so as to coat the outer periphery of the negative electrode tab in the vicinity of the connecting part thereof, i.e. vicinity of the end of the negative electrode collector.

In addition, in the positive electrode for solid-state batteries 20 constituting the solid-state battery 100, the positive electrode active material layer 21 is laminated on both sides of the positive electrode collector 25.

The positive electrode tab 22 connects to the positive electrode collector 25, and the positive electrode tab coating layer 23 is arranged so as to coat the outer periphery of the positive electrode tab 22 in the vicinity of the connecting part thereof, i.e. vicinity of the end of the positive electrode collector 25.

(Surface Area of Positive Electrode Active Material Layer)

In the solid-state battery of the present invention, the surface area of the positive electrode active material layer is preferably no more than the surface area of the negative electrode active material layer. In the case of the surface area of the negative electrode active material layer being smaller than the surface area of the positive electrode active material layer, it is not preferable since the risk of Li electrode position to the end occurring becomes higher.

In addition, by making the surface area of the positive electrode active material layer smaller than the surface area of the negative electrode active material layer, it is possible to improve the durability of the obtained solid-state battery.

In addition, in the case of the positive electrode for solid-state batteries of the present invention having a positive electrode collector coating layer on the outer peripheral section of the positive electrode active material layer, and the surface area of the positive electrode active material layer being smaller than the surface area of the negative electrode active material layer, it is possible to more greatly exhibit the effects of the present invention.

(Surface Area of Positive Electrode for Solid-State Batteries)

In the solid-state battery of the present invention, the surface area of the positive electrode for solid-state batteries, the surface area of the negative electrode for solid-state batteries, and the surface area of the solid electrolyte layer are preferably substantially the same.

By making the surface areas of all layers constituting the laminate of the solid-state battery as substantially the same, it is possible to suppress the occurrence of displacement in the lamination step upon forming the solid-state battery.

In addition, it is possible to suppress the occurrence of cracks in the lamination pressing step for integrating the laminate.

In the present invention, at least the positive electrode for solid-state batteries has a positive electrode collector coating layer consisting of an insulation layer formed by insulating material and/or a solid electrolyte layer formed by solid electrolyte, on the outer periphery and end face of the positive electrode collector.

By controlling the thickness of this coating layer, it is possible to make substantially the same surface areas of the negative electrode for solid-state batteries, etc.

(Negative Electrode for Solid-State Batteries)

The negative electrode for solid-state batteries constituting the solid-state battery of the present invention includes the negative electrode collector, and the negative electrode active material layer containing negative electrode active material formed on the negative electrode collector.

(Negative Electrode Active Material Layer)

The negative electrode active materials which can be applied to the negative electrode for solid-state batteries constituting the solid-state battery of the present invention are not particularly limited, and it is possible to adopt a well-known substance as the negative electrode active material of the solid-state battery.

There are no particular limitations for the composition thereof, and may contain solid electrolyte, conductive auxiliary agent, binding agent, etc.

As the negative electrode active material contained in the negative electrode active material layer of the present invention, for example, lithium metal, a lithium alloy such as Li—Al alloy or Li—In alloy, a lithium titanate such as Li₄Ti₅O₁₂, and carbon materials such as carbon fiber and graphite can be exemplified.

(Negative Electrode Collector)

The collectors which can be applied to the negative electrode for solid-state batteries constituting the solid-state battery of the present invention are not particularly limited, and it is possible to apply a well-known collector which can be used in the negative electrode of a solid-state battery.

For example, metal foils such as SUS foil and Cu foil can be exemplified.

(Negative Electrode Active Material Layer Unformed Section and Negative Electrode Collector Coating Layer)

The negative electrode collector in the negative electrode for solid-state batteries constituting the solid-state battery of the present invention preferably has the negative electrode active material layer unformed section in which the negative electrode active material layer is not formed, on at least one side of the outer peripheral section of a surface having the negative electrode active material layer; and has negative electrode collector coating layer consisting of the insulation layer formed by insulating material and/or the solid electrolyte layer formed by solid electrolyte, on the negative electrode active material layer unformed section, and the end face connected to the negative electrode active material layer unformed section.

By arranging the negative electrode collector coating layer also on the negative electrode for solid-state batteries, and not only on the positive electrode for solid-state batteries, upon laminating the solid electrolyte and positive electrode for solid-state batteries in the solid-state battery manufacturing process, it is possible to have the negative electrode collector coating layer present on the outer periphery of a void of the negative electrode active material layer unformed section existing at a height corresponding to the thickness of the negative electrode active material layer.

Therefore, in the pressing step during solid-state battery manufacturing, the void on the negative electrode side comes to be supported by the negative electrode collector coating layer, whereby it is possible to further suppress the occurrence of cracks.

In addition, by the negative electrode for solid-state batteries having the negative electrode collector coating layer not only on the negative electrode active material layer unformed section, but also at the same time on the end face connected to the negative electrode active material layer unformed section, even in a case of the positive electrode tab connected to the positive electrode for solid-state batteries coming into contact with the negative electrode for solid-state batteries at the time of solid-state battery manufacture, at the time of solid-state battery usage, etc., it becomes possible to prevent short circuit.

In addition, by not only the positive electrode for solid-state batteries, but also the negative electrode for solid-state batteries having the negative electrode collector coating layer, the profile of the negative electrode for solid-state batteries becomes clear, and it is possible to further suppress laminate displacement occurring during manufacture.

It should be noted that the negative electrode active material layer unformed section and negative electrode collector coating layer may be configurations similar to the aforementioned positive electrode active material layer unformed section and positive electrode collector coating layer.

(Thickness of Negative Electrode Collector Coating Layer)

The thickness of the negative electrode collector coating layer is preferably made substantially the same as the thickness of the negative electrode active material layer.

If the thickness of the negative electrode collector coating layer is substantially the same as the thickness of the negative electrode active material layer, it will be substantially the same as the height of the void of the negative electrode active material layer unformed section existing at a height corresponding to the thickness of the negative electrode active material layer.

Therefore, it becomes possible to minimize the planar tolerance and parallelism tolerance of the obtained positive electrode for solid-state batteries, a result of which the volume upon multi-layering becomes smaller, which can contribute to higher energy.

In addition, since the geometric tolerance upon making a laminate body is small, it is possible to suppress the occurrence of cracks since it becomes possible to uniformly apply pressure in the lamination pressing during manufacturing.

(Solid Electrolyte Layer)

So long as the solid electrolyte layer constituting the solid-state battery of the present invention is in a state in which ionic conductance between the positive electrode for solid-state batteries and negative-electrode for solid-state batteries is possible, the thickness, shape, etc. are not particularly limited.

In addition, the manufacturing method is not particularly limited.

The type of solid electrolyte constituting the solid electrolyte layer is also not particularly limited.

For example, it is possible to exemplify a sulfide-based inorganic solid electrolyte, NASICON-type oxide-based inorganic solid electrolyte, perovskite-type oxide inorganic solid modified electrolyte, etc.

In addition, the solid electrolyte constituting the solid-state battery of the present invention contains a binder and the like as necessary.

The compositional ratios of each substance contained the solid electrolyte are not particularly limited so long as the battery can operate properly.

(Application of Solid-State Battery)

The solid-state battery of the present invention can be used in various devices by modularization, for example.

The solid-state battery of the present invention can be suitably used as the power source of portable devices as a matter of course, for example, and also for electric vehicles, hybrid vehicles or the like.

### EXPLANATION OF REFERENCE NUMERALS

100 solid-state battery

10 negative electrode for solid-state batteries

11 negative electrode active material layer

12 negative electrode collector and negative electrode tab

13 negative electrode tab coating layer

20 positive electrode for solid-state batteries

21 positive electrode active material layer

22 positive electrode tab

23 positive electrode tab coating layer

24 positive electrode collector coating layer

25 positive electrode collector

26 positive electrode active material layer unformed section

30 solid electrolyte layer

41 support plate

42 insulation film

1. A positive electrode for solid-state batteries comprising: a positive electrode collector, and a positive electrode active material layer containing a positive electrode active material formed on the positive electrode collector,
wherein the positive electrode collector has, on at least one side of an outer peripheral section of a surface having the positive electrode active material layer, a positive electrode active material unformed section in which the positive electrode active material layer is not formed, and
has, on the positive electrode active material layer unformed section, and an end face of the positive electrode collector connected to the positive electrode active material layer unformed section, a positive electrode collector coating layer configured by either one of an insulation layer formed by an insulating material or a solid electrolyte layer formed by solid electrolyte.

2. The positive electrode for solid-state batteries according to claim 1, wherein thickness of the positive electrode collector coating layer formed on the positive electrode collector is substantially the same as thickness of the positive electrode active material layer.

3. The positive electrode for solid'-state batteries according to claim 1, wherein the positive electrode for solid-state batteries has a positive electrode tab connected to the positive electrode collector, and
wherein the positive electrode tab at least partly has a positive electrode tab coating layer consisting of a insulating material.

4. A manufacturing method for a positive electrode for solid-state batteries including a positive electrode collector, and a positive electrode active material layer containing a positive electrode active material formed on the positive electrode collector, the method comprising the steps of:
forming a positive electrode active material yer containing a positive electrode active material on the positive electrode collector; and
forming a positive electrode collector coating layer configured by either one of an insulation layer formed by an insulating material and/or a solid electrolyte layer formed by a solid electrolyte, in a region not having the positive electrode active material layer including an end face of the positive electrode collector.

5. A solid-state battery comprising:
a positive electrode for solid-state batteries containing a positive electrode collector, and a positive electrode active material layer including positive electrode active material formed on the positive electrode collector;
a negative electrode for solid-state batteries containing a negative electrode collector, and a negative electrode active material layer including a negative electrode active material formed on the negative electrode collector; and
a solid electrolyte layer disposed between the positive electrode for solid-state batteries and the negative electrode for solid-state batteries,
wherein the positive electrode for solid-state batteries is the positive electrode for solid-state batteries according to claim 1.

6. The solid-state battery according to claim 5, wherein surface area of the positive electrode active material layer is no more than surface area of the negative electrode active material layer.

7. The solid-state battery according to claim 5, wherein surface area of the positive electrode for solid-state batteries, surface area of the negative electrode for solid-state batteries, and surface area of the solid electrolyte layer are substantially the same.

8. The solid-state battery according to claim 5,
wherein the negative electrode collector has a negative electrode active material layer unformed section in which the negative electrode active material layer is not formed, on at least one side of an outer peripheral section of a surface having the negative electrode active material layer, and
has a negative electrode collector coating layer consisting of an insulation layer formed by an insulating material and/or a solid electrolyte layer formed by a solid electrolyte, on the negative electrode active material layer unformed section and an end face connected to the negative electrode active material layer unformed section.

9. The solid-state battery according to claim 8, wherein thickness of the negative electrode collector coating layer is substantially the same as thickness of the negative electrode active material layer.

10. The positive electrode for solid-state batteries according to claim 2, wherein the positive electrode for solid-state batteries has a positive electrode tab connected to the positive electrode collector, and
wherein the positive electrode tab at least partly has a positive electrode tab coating layer consisting of an insulating material.

11. A solid-state battery comprising:
a positive electrode for solid-state batteries containing a positive electrode collector, and a positive electrode active material layer including positive electrode active material formed on positive electrode collector;
a negative electrode for solid-state batteries containing a negative electrode collector, and a negative electrode active material layer including a negative electrode active material formed on the negative electrode collector; and
a solid electrolyte layer disposed between the positive electrode for solid-state batteries and the negative electrode for solid-state batteries,
wherein the positive electrode for solid-state batteries is the positive electrode for solid-state batteries according to claim

12. A solid-state battery comprising:
a positive electrode for solid-state batteries containing a positive electrode collector, and a positive electrode active material layer including positive electrode active material formed on the positive electrode collector,
a negative electrode for solid-state batteries containing a negative electrode collector, and a negative electrode active material layer including a negative electrode active material formed on the negative electrode collector; and
a solid electrolyte layer disposed between the positive electrode for solid-state batteries and the negative electrode for solid-state batteries,
wherein the positive electrode for solid-state batteries is the positive electrode for solid-state batteries according to claim 3.

13. The solid-state battery according to claim 6, wherein surface area of the positive electrode for solid-state batteries, surface area of the negative electrode for solid-state batteries, and surface area of the solid electrolyte layer are substantially the same.

14. The solid-state battery according to claim 6, wherein the negative electrode collector has a negative electrode active material layer unformed section in which the negative electrode active material layer is not formed, on at least one side of an outer peripheral section of a surface having the negative electrode active material layer, and has a negative electrode collector coating layer consisting of an insulation layer formed by an insulating material and/or a solid electrolyte layer formed by a solid electrolyte, on the negative electrode active material layer unformed section and an end face connected to the negative electrode active material layer unformed section.

15. The solid-state battery according to claim 7, wherein the negative electrode collector has a negative electrode active material Dyer unformed section in which the negative electrode active material layer is not formed, on at least one side of an outer peripheral section of a surface having the negative electrode active material layer, and has a negative electrode collector coating layer consisting of an insulation layer formed by an insulating material and/or a solid electrolyte layer formed by a solid electrolyte, on the negative electrode active material layer unformed section and an end face connected to the negative electrode active material layer unformed section.
